(19) United States
(12) Patent Application Publication
(10) Pub. No.: US 2006/0192107 A1
(43) Pub. Date: Aug. 31, 2006

(54) Methods and apparatus for porous membrane electrospray and multiplexed coupling of microfluidic systems with mass spectrometry

(76) Inventors: Donald L. DeVoe, Bethesda, MD (US); Yingxin Wang, Columbia, MD (US); Cheng S. Lee, Ellicott City, MD (US); Yan Li, Bethesda, MD (US)

Correspondence Address: Donald L. DeVoe, 5619 Sonoma Road, Bethesda, MD, 20817, US

(21) Appl. No.: 11/242,842

(22) Filed: Oct. 5, 2005

Related U.S. Application Data
(60) Provisional application No. 60/616,525, filed on Oct. 7, 2004.

(51) Int. Cl. B01D 59/44

(52) U.S. Cl. 250/288

(57) ABSTRACT

Disclosed are an apparatus, system, and method for performing electrospray of biomolecules, particularly peptides, polypeptides, and proteins. The apparatus comprises at least (1) a microfluidic substrate for containing an electrospray microchannel for delivering analyte molecules to a side edge of the substrate, and (2) a porous membrane attached to the side edge for performing electrospray from the exposed membrane surface. In one preferred embodiment, the exposed membrane surface is positioned above a target surface for depositing analyte molecules onto the target surface by electrospray. In another preferred embodiment, a proteolytic enzyme is bound to the porous membrane for performing protein digestion during electrospray.

### CROSS-REFERENCE TO RELATED APPLICATIONS

This application claims priority from U.S. Provisional Patent Application Ser. No. 60/616,525, filed Oct. 7, 2004, which is incorporated herein by reference in its entirety.

This invention was made in part with government support under Grants No. R43 EB000453 and GM62738 from the National Institutes of Health, and Contract No. W911SR-04-C-0014 from the U.S. Army. Accordingly, the U.S. government may have certain rights to this invention.

### BACKGROUND

1. Field of Invention

The invention relates to devices and methods for performing electrospray from capillary or planar microfluidic systems. The invention further relates to devices and methods for interfacing microfluidic systems with mass spectrometry. The device includes at least a reservoir, an electrode, a microchannel possessing a first end and a second end, and a porous membrane attached to the second end of the microchannel.

2. Background of the Invention

Microfluidic and capillary systems offer the potential for performing liquid-phase biomolecular analyses with increased throughput and sensitivity while significantly reducing cost. Ultimately, high resolution molecular analysis requires the coupling of these systems with mass spectrometry (MS) for accurate mass identification. Electrospray ionization (ESI), which utilizes a strong local electric field to transfer ions from solution to the gas phase in a fine spray at atmospheric pressure, is a commonly used approach for coupling both microfluidic and capillary analytical systems to mass spectroscopy by direct ESI-MS interfacing.

Various approaches to fabricating ESI interfaces into microfluidic systems have been reported. External interfaces have been demonstrated by inserting a capillary spray tip into microchannel exits, or by using a liquid junction to couple the microfluidic device to capillary-based separation systems followed by capillary ESI-MS. Although these techniques have shown excellent electrospray performance, they are not fully integrated with the microfluidic channels and thus suffer from large dead volumes which can lead to broadening of separation bands, and difficulty with fabricating high density electrospray tip arrays. Another method uses the flat surface at the microchannel exit, defined by cutting the substrate to expose the channel opening, to create the electrospray emitter. While straightforward, this approach leads to difficulty in consistently establishing well defined, stable Taylor cones at the microchannel exit due to liquid spreading, even for hydrophobic surfaces such as glass. In addition to increasing Taylor cone volume, liquid spreading at the exit also limits the ability to realize tightly spaced arrays of multiple ESI tips, since crosstalk between adjacent channels poses a significant problem. A further need arises from a desire to achieve stable electrospray when very low bulk fluid flow rates are imposed on the electrospray channel.

Several approaches have been explored to improve the stability of the electrospray process while also reducing exit spreading for integrated microchip ESI devices. For example, shaped spray tips have been fabricated from the bulk substrate material at the channel exit, using silicon (e.g. G. A. Shultz, T. N. Corso, S. J. Prosser, S. Zhang, Anal. Chem. 2000, 72, 4058-4063) and various polymers (e.g. K. Tang, Y. Lin, D. W. Matson, T. Kim, R. D. Smith, Anal. Chem. 2001, 73, 1658-1663). Similarly, the addition of thin parylene tips bonded at the channel exit to form a wicking structure has also been demonstrated (J. Kameoka, R. Orth, B. Ilic, D. Czaplewski, T. Wachs, H. G. Craighead, Anal. Chem. 2002, 74, 5897-5901). In general, shaped tips have been shown to significantly reduce or eliminate liquid spreading and provide very good spray stability, but are relatively difficult to fabricate, requiring additional fabrication steps including mechanical machining of the substrate or the use of additional lithographically-patterned material layers in the microfluidic system.

A simpler method for improving the performance of integrated ESI tips involves increasing the hydrophobicity of the channel exit, either by application of a surface coating, or by using polymer substrates with high native hydrophobicity. The latter approach has been shown to limit liquid spreading and assist in maintaining relatively small Taylor cone volumes, but does not prevent drift in the position of the Taylor cone away from the channel exit (T. C. Rohner, J. S. Rossier, H. H. Girault, Anal. Chem. 2001, 73, 5353-5357). In addition, for the case of thin film hydrophobic coatings, damage to the coating during the electrospray process can occur. For example, using a monolayer of (n-octyl) covalently-attached to the exit surface of a glass microchip, stable electrospray was limited to under 5 min at a flow rate between 100-200 nL/min before the coating was damaged (Q. Xue, F. Foret, Y. M. Dunayevskiy, P. M. Zavracky, N. E. McGruer, B. L. Karger, Anal. Chem. 1997, 69, 426-430). Similarly, CF₄ exposure in an RF plasma system has been shown to increase the hydrophobicity of laser-shaped polycarbonate (PC) ESI tips (K. Tang, Y. Lin, D. W. Matson, T. Kim, R. D. Smith, Anal. Chem. 2001, 73, 1658-1663) for reduced liquid spreading and improved ESI stability. However, the longevity of CF₄ plasma surface modifications can be limited, and the processing costs are significant. An alternate approach incorporated by reference herein involves the use of a hydrophobic porous membrane bonded to the microchannel exit (Y. Wanǵ, J. Cooper, C. S. Lee, D. L. DeVoe, Lab On A Chip 2004, 4, 263-267).

A further need arises from a desire to interface multiplexed microfluidic systems with mass spectrometry. Despite the potential for ESI-MS analysis from microfluidic systems, there is often a need to decouple on-chip biomolecular separations from MS analysis. For example, the time scales for biomolecular separations and MS data acquisition are often incompatible. Another important demand for off-line analysis arises from the need for coupling multiple parallel (multiplexed) microchannels to mass spectrometry, in which simultaneous ESI-MS from each separation channel is not feasible due to physical constraints. Matrix assisted laser desorption ionization—mass spectrometry (MALDI-MS) and related methods including desorption ionization on silicon—mass spectrometry (DIOS-MS) are powerful analytical techniques commonly employed for off-line MS analysis following capillary separations (e.g. T. Rejtar, P. Hu, P. Juhasz, J. M. Campbell, M. L. Vestal, J. Preisler, B. L. Karger, Journal of Proteome Res. 2002, 1, 171-179). Although it is a serial process, the high duty cycle of MALDI-MS analysis enables high throughput for large numbers of samples deposited on a single target plate. Preparation of MALDI targets is often carried out by the dried-droplet method, in which spotting of an aliquot containing a mixture of sample and matrix solution is followed by air-drying of the deposited spot (M. Karas, F. Hillenkamp, Anal. Chem. 1988, 60, 2299-2301.). The quality of MALDI data is highly dependent on the way analyte is prepared on the target plate. Liquid-phase deposition methods including dried-droplet, fast solvent evaporation, sandwich, and two-layer preparation tend to suffer from poor homogeneity of crystallized sample, since matrix and analyte tend to partition during the solvent evaporation process, resulting in significant variations in mass resolution, intensity, and selectivity, and preventing meaningful quantitative analysis. As an alternative to mechanical pipetting or spotting, a number of studies have investigated the use of electrospray deposition of analytes from single capillaries onto MALDI targets, followed by MALDI-MS analysis. A number of studies have shown that electrospray deposition can markedly improve the homogeneity of sample on the MALDI target surface by reducing segregation of matrix/analyte components, leading to greatly enhanced repeatability (e.g. E. P. Go, Z. Shen, K. Harris, G. Siuzdak, Anal. Chem. 2003, 75, 5475-5479; S. D. Hanton, I. Z. Hyder, J. R. Stets, K. G. Owens, W. R. Blair, C. M. Guttman, A. A. Giuseppetti, J. Am. Soc. Mass Spectrom. 2004, 15, 168-179), thereby enabling improved quantitative analysis. Furthermore, electrospray deposition has been shown to significantly improve the precision of molecular mass measurements during MALDI-MS. There is a need to bring these benefits to microfluidic analytical systems, in particular for microfluidic systems containing two or more microchannels from which parallel analyses are desired. This concept is described by Wang et al. (Y. Wang, Y. Zhou, B. Balgley, J. Cooper, C. S. Lee, D. L. DeVoe, Electrophoresis 2005, 26, 3631-3640) and is incorporated by reference herein.

The present invention fulfills these and other needs.

### SUMMARY OF THE INVENTION

In one aspect of the present invention, stable electrospray from the flat edge of a microfluidic chip is enabled through the addition of a porous hydrophobic membrane to the channel exit surface. The porous membrane provides a controllable and repeatable hydrophobic surface to constrain lateral dispersion of liquid from the tip exit. The base of the resulting Taylor cone formed during electrospray is thus constrained to remain positioned at the channel exit.

In another aspect of the invention, multiple electrospray tips may be formed in a single microfluidic substrate, with one or more microchannels used to deliver liquid to each of the tips. By using a hydrophobic porous polymer to constrain lateral dispersion of liquid at the exposed face of the membrane, spacing between adjacent tips may be as small as the diameter of the Taylor cones formed during the electrospray process, enabling dense arrays of electrospray tips to be formed with negligible contamination of analyte molecules between the tips.

In another aspect of the invention, an interface is provided between multiplexed microchannels and mass spectrometry through the simultaneous deposition of analyte molecules from a multiple channels within a microfluidic substrate onto a MALDI target by electrospray.

According to another aspect, the porous membrane can be made from a conductive material, such that the voltage required for electrospray can be delivered directly to the membrane rather than through liquid within the electrospray microchannel.

In another aspect, the porous exit surface of the membrane serves as a dense array of nanoscale electrospray tips, enabling the generation of stable electrospray at low bulk fluid flow rates.

According to another aspect, the highly porous membrane reduces the pressure required to achieve sufficient liquid flow for stable electrospray when compared to pulled-silica nanospray tips.

According to another aspect, the porous membrane reduces the pressure required to achieve sufficient liquid flow for stable electrospray when compared to pulled-silica nanospray tips.

Another aspect of the invention is the ability to selectively bind molecules to the membrane surface, for example through hydrophobic-hydrophobic interactions, thereby enabling controlled interactions between the bound molecules and analyte molecules passing through the membrane during the electrospray process. The high surface area of the membrane may serve to enhance the kinetics of the molecular interactions. For example, a proteolytic enzyme such as trypsin may be bound to the membrane through hydrophobic interactions, and used to digest proteins passing through the membrane in real-time, while electrospraying the resulting protein digest. Other molecular species chosen to interact with the analyte may similarly be bound to the membrane. For example, a phosphotase may be bound to the membrane to enable the removal of phosphorylated groups from analyte proteins during electrospray.

These and other features and advantages of the invention will be more fully appreciated from the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 shows an embodiment of the membrane electrospray device employing a capillary.

FIG. 2 shows an embodiment of the membrane electrospray device employing a microfluidic substrate.

FIG. 3 shows an embodiment of the membrane electrospray device with an integrated separation microchannel.

FIG. 4 shows an embodiment of the membrane electrospray device containing multiple electrospray elements within a single substrate.

FIG. 5 shows perspective and side views of an electrospray device coupled with a MALDI target, schematically depicting the deposition of analyte from the electrospray device onto the MALDI target.

### DETAILED DESCRIPTION OF THE INVENTION

I. Apparatus

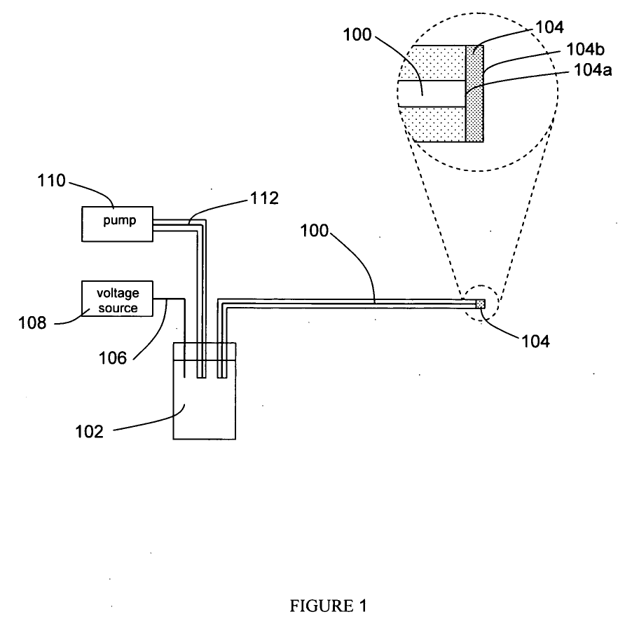

A preferred embodiment of the apparatus is depicted in FIG. 1. The apparatus comprises an electrospray microchannel 100, said electrospray microchannel possessing a first end and a second end, wherein the first end is in fluid communication with an electrospray reservoir 102, and a porous membrane 104 is affixed to the second end. The porous membrane, which possesses a bonded face 104a which is affixed to the second end of the electrospray microchannel such that the inner diameter of the electrospray microchannel is fully covered by the membrane, and an exposed face 104b which is opposite the bonded face. The membrane is bonded to the electrospray microchannel using one of several possible methods, such as thermal bonding, adhesive bonding, or solvent bonding. The apparatus further comprises an electrospray electrode 106, possessing a first end and a second end, wherein the first end of said electrode is in electrical communication with the fluid within the sealed reservoir 102, and the second end is connected to an electrospray voltage source 108. A flow control pump 110 is in fluid communication with the reservoir through a flow control microchannel, and the reservoir is sealed such that as fluid is pumped into the reservoir, a pressure differential develops between the reservoir and the exposed face of the porous membrane, resulting in the pumping of solution within the reservoir through the electrospray microchannel and across the membrane.

The microchannels may be fabricated from a number of different materials, including glass, silica, or plastic. The use of the term “microchannel” in the present invention is not intended to limit the invention to planar microfluidic systems, but rather is used to refer to any fluid-carrying channel including but not limited to silica or plastic capillary tubing. The microchannels need not be circular in cross-section. For example, the channels may be ellipsoidal, rectangular, or trapezoidal in cross-section, depending on the method used for their fabrication. Microchannels possessing inner diameters on the order of 10 μm to 100 μm may be desirable for applications involving small sample volumes, but larger or smaller inner diameters may also be used depending on the application.

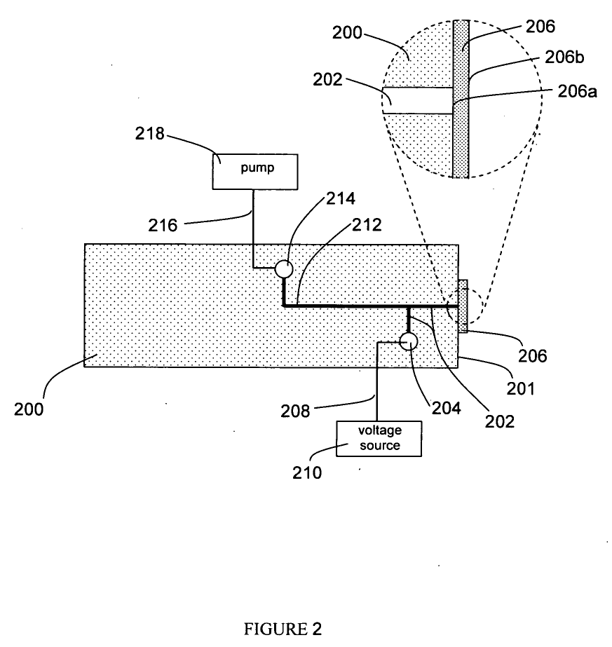

According to another embodiment, depicted in FIG. 2, the apparatus consists of a planar substrate 200 consisting of a plate possessing a top surface, a bottom surface, and at least one side edge 201. The substrate contains at least one electrospray microchannel 202, said electrospray microchannel possessing a first end and a second end, wherein the first end is in fluid communication with an electrospray reservoir 204, and wherein the second end terminates at the side edge of the substrate. A porous membrane 206 is affixed to the side edge of the substrate such that the second end of the electrospray microchannel is fully covered by the membrane. The porous membrane possesses a bonded face 206a which fully covers the second end of the electrospray microchannel, and an exposed face 206b which is opposite the bonded face. The bonded face of the membrane is bonded to the side edge of the substrate surrounding the second end of the electrospray microchannel using one of several possible methods, such as thermal bonding, adhesive bonding, or solvent bonding. The apparatus further comprises an electrospray electrode 208, possessing a first end and a second end, wherein the first end of said electrode is in electrical communication with the fluid within the electrospray reservoir 204, and the second end is connected to an electrospray voltage source 210. A flow control microchannel 212, possessing a first end and a second end, intersects the electrospray microchannel such that the first end of the flow control microchannel is in fluid communication with the electrospray microchannel at a point between the first and second ends of the electrospray microchannel. The second end of the flow control microchannel is in fluid communication with a flow control reservoir 214. A sealing means is also provided such that both the electrospray reservoir and the flow control reservoir may be sealed to prevent fluid leakage. A flow control capillary 216 provides a fluidic interface between the flow control reservoir and a flow control pump 218. The flow control pump serves to provide a flow of fluid through the external capillary, through the flow control microchannel, through at least a portion of the electrospray microchannel, and through the thickness of the porous membrane.

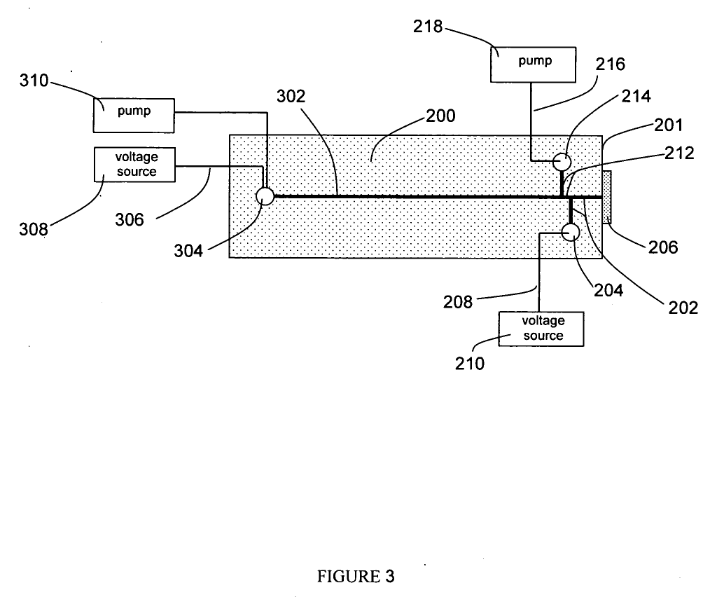

According to one embodiment of the invention, as depicted in FIG. 3, a separation microchannel 302 provides a fluidic connection between a separation reservoir 304 and a point on the flow control microchannel 212. A separation voltage source 308 is provided in electrical communication with the separation reservoir through an electrode 306. Pursuant to this arrangement, the voltage sources 210 and 308 may be configured to generate a high electric field along the length of the separation microchannel, such that charged analyte molecules introduced into the third microchannel at or near the third reservoir will migrate towards the first reservoir due to electrokinetic interactions with the electric field. The separation microchannel may contain a buffer solution selected such that capillary zone electrophoresis takes place during migration of the analyte molecules. Alternately, the separation microchannel may be filled with a sieving gel, such as polyacrylamide or polyethelyne oxide, such that capillary gel electrophoresis takes place during electrokinetic migration of the analyte plug. It will be appreciated to one skilled in the art that this embodiment could be configured to support alternative separation mechanisms such as liquid chromatography or electrokinetic chromatography. As selected portions or bands of analyte molecules elute from the separation microchannel into the flow control microchannel under the influence of the applied electric field, they may be hydrodynamically pumped into the electrospray microchannel and through the porous membrane 206 bonded to the microfluidic substrate 200, by activating a flow control pump 218 in fluid communication with the flow control reservoir 214. As analyte molecules reach the exposed surface of the porous membrane, they may be electrosprayed from the exposed membrane surface.

In the various embodiments described herein, the porous membrane may be fabricated from a wide range of suitable materials. Either hydrophobic and hydrophilic materials may be desirable, depending on the application. According to a preferred embodiment, the porous membrane is fabricated from a hydrophobic material such as polytetrafluoroethylene (PTFE) or hydrophobic polyvinylidene fluoride (PVDF). Hydrophobic materials tend to prevent the wicking of aqueous solutions, thereby serving to constrain the lateral spreading of fluid at the exit surface during the electrospray process. Hydrophobic membrane materials also provide the benefit of enabling the bonding of many biomolecules such as peptides and proteins to the membrane surface by hydrophobic-hydrophobic interactions. Hydrophilic materials, such as polyethersulfone or hydrophilic polyvinylidene fluoride (PVDF), may be used to reduce the binding of hydrophobic molecules passing through the membrane. Non-polymer materials such as porous silica which offer high structural rigidity and strength may also be desirable to facilitate easier bonding to the microchannel substrate. In general, it is preferable to use materials which remain electrically, mechanically, and chemically stable when exposed to high temperatures and high electric fields. It may be preferable to use a membrane with a thickness between 5-100 microns, an average pore size between 0.1-1.0 microns, and a porosity of 85% or greater.

The substrate may be fabricated from glass, silicon, plastic, or other material as commonly employed in microchannel manufacturing. According to a preferred embodiment, the substrate is fabricated from a polymer material with a glass transition temperature substantially lower than the thermal deformation temperature of the porous membrane material. For example, if the porous membrane is fabricated from a PTFE formulation possessing a glass transition temperature over 200° C., the microfluidic substrate may be fabricated from polymethylmethacrylate (PMMA), polycarbonate (PC), or cyclic olefin polymer materials with glass transition temperatures under 150° C. The lower glass transition temperature ensures that the porous membrane may be thermally bonded to the microfluidic substrate without significantly deforming the membrane pores during the bonding process.

Specific molecules may be bound to the membrane surface, for example through hydrophobic-hydrophobic interactions or by binding to functional chemical groups on the membrane surface, thereby enabling controlled interactions between the bound molecules and analyte molecules passing through the membrane during the electrospray process. For example, a proteolytic enzyme such as trypsin may be bound to the membrane through hydrophobic interactions, and used to partially or fully digest proteins passing through the membrane in real-time while electrospraying the resulting protein digest. Furthermore, multiple molecular species with desired functionality may be bound to a single membrane. For example, a phosphotase with activity towards phosphorylated residues may be combined with a serine protease such as trypsin which cleaves lysine and arginine residues.

The apparatus may be useful for performing electrospray ionization, wherein fully desolvated ions are expelled from the electrospray tip. Alternately, the invention may be used for electrospray deposition, wherein the distance between the electrospray tip and target is sufficiently small to prevent complete desolvation of the sample stream exiting the electrospray apparatus before the sample molecules impinge upon the target. The use of electrospray deposition without fully desolvating the analyte may be desirable for certain applications. For example, incomplete desolvation may be desirable when depositing analyte onto a target for MALDI-MS analysis, since the residual solvent may enhance the ability for deposited molecules to interact effectively with a pre-deposited matrix solution for proper crystallization.

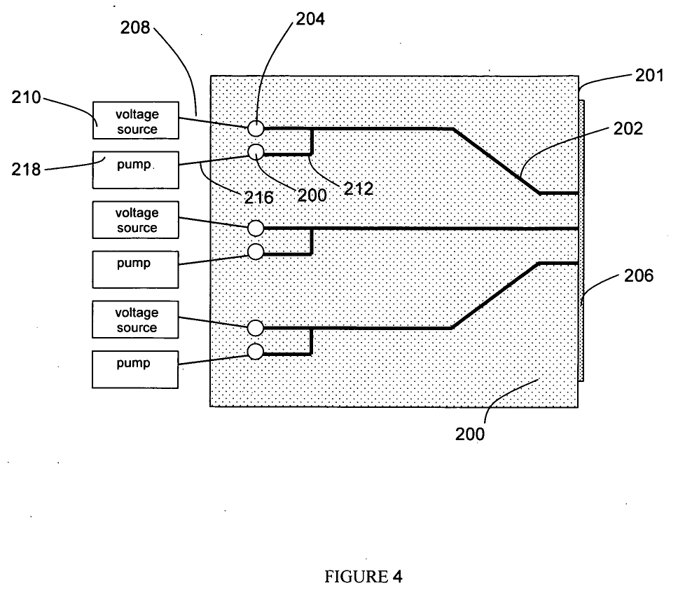

According to another embodiment of the invention, as depicted in FIG. 4, a microfluidic substrate 200 is provided, with said substrate possessing two or more electrospray microchannels 202 configured such that the second ends of each of the electrospray microchannels terminate at different locations along the side edge 201 of the substrate, and a porous membrane 206 is attached to the side edge such that each of the second ends of the electrospray microchannels are covered by the membrane. By selecting a highly hydrophobic porous membrane material, such as PTFE, liquid exiting an electrospray microchannel end and passing through the membrane is prevented from substantially traversing along the exposed surface of the membrane, thereby constraining liquid from adjacent microchannel ends from mixing during electrospray.

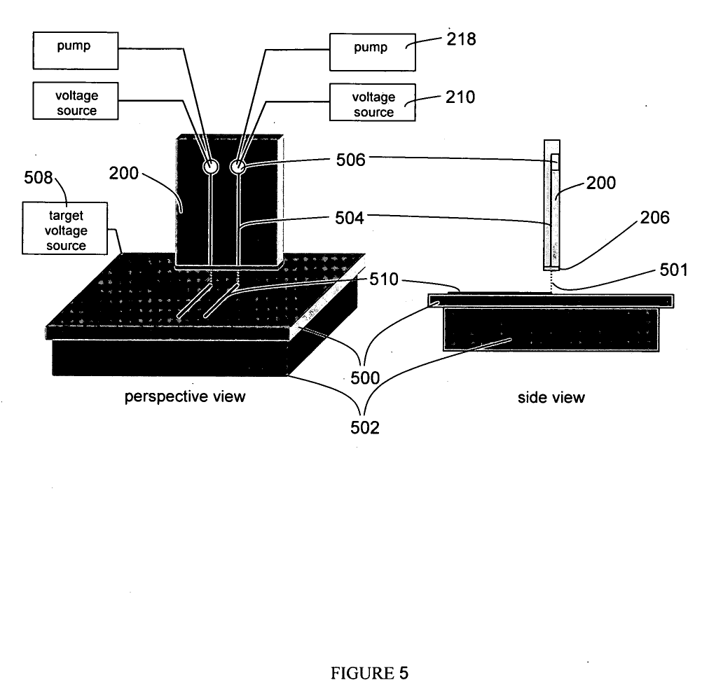

According to another aspect of the invention, depicted in FIG. 5, an electrically conductive MALDI target 500 attached to a positioning stage 502 is provided. A microfluidic substrate is provided, said substrate containing at least one microchannel 504, possessing a first end in fluidic communication with a reservoir 506 and a second end terminating at a side edge of the microfluidic substrate. A porous membrane 206 is affixed to the side edge of the substrate such that the second end of the microchannel is fully covered by the membrane. The microfluidic substrate is positioned above the MALDI target such that the exposed surface of the membrane is separated from the MALDI target by a small gap. An electrospray voltage source 210 is placed in electrical communication with the reservoir 506, and a flow control pump 218 is placed in fluidic communication with the reservoir. A sealing means is provided such that the reservoir may be sealed to prevent liquid or gas leakage out of the reservoir. A target voltage source 508 is placed in electrical communication with the conductive MALDI target plate.

II. Methods

In one aspect of the invention, a method is provided for binding selected species of molecules to the electrospray membrane prior to performing electrospray of analyte molecules. Referring to FIG. 1, a solution containing one or more species of binding molecules may be pumped through the electrospray microchannel 100 and across the porous membrane 104, thereby exposing substantially all of the internal membrane surface in the region surrounding the second end of the capillary to the binding molecules. The solution may be pumped at a continuous flow rate for a predetermined period of time to achieve the desired level of binding activity with a continuous influx of new molecules, or the solution may be introduced and the flow halted for a period of time to achieve the desired level of binding activity without introducing new molecules during the binding process. The temperature of the apparatus may be controlled during this process, for example to enhance molecular diffusion or binding kinetics. If desired, one or more additional solutions, each containing one or more species of binding molecules, may be sequentially pumped through the capillary and across the membrane. Once the desired binding levels have been achieved for all binding species, a solution free of binding molecules is pumped through the membrane to flush any unbound molecules from the membrane pores and capillary. A higher flow rate may be used during the flushing step to increase the amount of spreading of solution as it passes through the membrane, thereby assisting in the removal of unbound molecules which may have diffused laterally through the membrane.

In another aspect, the invention includes a method for performing electrospray of analyte molecules from the exposed membrane surface. Referring to FIG. 1, a solution containing analyte molecules is introduced into the sealed reservoir 102. The exposed surface of the membrane 104b is positioned a fixed distance from an electrospray target. The target may comprise the entry orifice of a mass spectrometer, or it may comprise a MALDI target plate. The spacing between the membrane and target typically ranges from 0.5 mm to 5 mm. Using a flow control pump 110, a fluid flow rate is established to introduce solution from the reservoir, through the electrospray capillary 100, and across the membrane. After solution appears on the exposed face of the membrane, a new flow rate is established as the desired electrospray flow rate, typically between 10 and 200 nL/min. The electrospray voltage source 108 is turned on, and the applied voltage is gradually increased until stable electrospray current is measured through the capillary.

In another aspect, a method for coupling electrospray with molecular separations is provided. Referring to FIG. 3, the method consists of providing a secondary pump (not shown) which is placed in fluid communication with the separation reservoir 304. The secondary pump is activated to introduce a separation medium along the length of the separation microchannel 302, while the flow control pump is activated to provide a flow of electrospray buffer solution along the length of the flow control microchannel 212 and electrospray microchannel 202. The flow rates for the flow control pump and secondary pump 310 are adjusted such that the separation microchannel is substantially filled with separation medium, while the electrospray and flow control microchannels are substantially filled with electrospray buffer solution. The material used for the separation medium depends on the desired separation mechanism, and may consist of a sieving gel, a buffer solution, an ampholyte medium, or a chromatographic material. After filling each microchannel with either separation medium or electrospray buffer, the electrospray reservoir is sealed, and a plug of analyte molecules is introduced into the separation microchannel. The plug may be introduced by injection into the separation reservoir 304, or it may be introduced using one of several common methods such as a microfluidic cross-injection method in which the intersection between the separation microchannel and an additional injection microchannel (not shown) defines the plug volume. Voltages are then applied to the separation voltage source 308 and electrospray voltage source 210 to generate an electric field along the length of separation microchannel. The polarity of the field is chosen based on the charge state of the analyte and the separation mechanism being employed. For example, if the analyte consists of proteins complexed with negatively-charged sodium dodecyl sulfate molecules, and the separation microchannel is filled with a sieving gel for performing capillary gel electrophoresis, a high positive voltage may be applied in the separation reservoir, while the electrospray reservoir 204 is electrically grounded. Concurrent with generation of the electric field, the flow control pump is activated to create a flow of electrospray buffer along the flow control microchannel, through a portion of the electrospray microchannel, and through the porous membrane 206. The buffer flow serves to deliver the portions of the separated analyte plug to the electrospray tip as analyte molecules elute out of the separation microchannel and into the flow control microchannel under the influence of the generated electric field. The buffer flow also provides makeup fluid during the electrospray process, replenishing liquid lost at the exposed surface of the porous membrane. This process may be continued until all separated fractions of the original analyte plug have been expelled from the device by electrospray.

In another aspect, a method for depositing analyte molecules onto a MALDI target is provided. Referring to FIG. 5, the electrospray voltage source 210 and target voltage source 508 are activated using suitable voltages such that an electric field is established between the fluid within the microchannel 504 and the MALDI target 500. The reservoir 506 is sealed, and the flow control pump is activated to provide a flow of liquid along the microchannel and across the thickness of the porous membrane 206. By selecting appropriate voltage and flow rates, a stream of solvated ions 501 is generated by electrospray. The stream of solvated ions follows the electric field lines between the microchannel and the MALDI target, thereby depositing molecules within the stream of solvated ions onto the MALDI target. The deposited molecules 510 may be deposited at a single point by maintaining the MALDI target at a fixed position, or deposited at different positions by moving the MALDI target using the positioning stage 502 during electrospray. Changes in position may follow different velocity profiles. For example, a constant velocity profile may be used to produce a continuous line of deposited molecules, or a discontinuous velocity profile may be used to deposit a series of discrete spots of deposited molecules onto the MALDI target. A matrix solution commonly used to enhance the ionization of deposited molecules during MALDI-MS analysis may be deposited onto the MALDI target prior to electrospray deposition, after electrospray deposition, or both.

We claim:

1. An apparatus for performing electrospray, said apparatus comprising:
a) a substrate containing one or more microchannels, said substrate possessing at least one surface;
b) at least one electrospray microchannel, said microchannel possessing a first end and a second end, wherein the second end terminates at the substrate surface;
c) at least one reservoir, wherein the reservoir is in fluid communication with the first end of the electrospray microchannel; and
d) at least one porous membrane, said membrane possessing a bonded side and an exposed side, wherein the membrane contains interconnected pores which provide a continuous fluid flow path between the bonded side and the exposed side, and wherein the bonded side of the porous membrane is attached to the substrate surface such that the membrane substantially covers the second end of the electrospray microchannel;

2. The apparatus of claim 1, wherein the substrate is a planar microfluidic substrate formed from any material commonly used in the manufacture of microfluidic systems including plastic, glass, quartz, or silicon.

3. The apparatus of claim 1, wherein the substrate is a capillary tube formed from any material commonly used in the manufacture of capillaries including glass or plastic.

4. The apparatus of claim 1, wherein the cross-sectional area of the second end of the electrospray microchannel is between 100 μm² and 50,000 μm².

5. The apparatus of claim 1, wherein the porous membrane is between 5 microns and 50 microns thick.

6. The apparatus of claim 1, wherein the porous membrane possess an average porosity of between 70% and 95%, and wherein the average pore size is between 0.1 micron and 1 micron.

7. The apparatus of claim 1, wherein the porous membrane is formed from a polymer material.

8. The apparatus of claim 7, wherein the polymer is a hydrophobic polymer such as polytetrafluoroethylene (PTFE).

9. The apparatus of claim 7, wherein the polymer is a hydrophilic polymer such as polyvinylidene fluoride (PVDF) or hydrophilized PTFE.

10. The apparatus of claim 1, wherein the porous membrane is formed from an electrically conductive material.

11. The apparatus of claim 1, said apparatus further comprising:
a) an electrospray target;
b) a first voltage source in electrical communication with the fluid within the electrospray reservoir;
c) a second voltage source in electrical communication with the electrospray target; and
d) at least one pumping means in fluid communication with the electrospray reservoir.

12. The apparatus of claim 1, said apparatus further comprising:
a) a current sensor for monitoring electrical current through the electrospray microchannel; and
b) a computer control system for adjusting the applied voltage to maintain the current through the electrospray channel within a predefined range.

13. The apparatus of claim 1, wherein one or more species of binding molecules are bound to the surfaces of the interconnected pores within the porous membrane.

14. The apparatus of claim 13, wherein at least one of the species of binding molecules is a proteolytic enzyme.

15. The apparatus of claim 11, wherein the electrospray target comprises the orifice of an electrospray-ionization mass spectrometer.

16. The apparatus of claim 11, wherein the electrospray target comprises a surface made from a material suitable for MALDI-MS analysis;

17. The apparatus of claim 11, wherein the electrospray target comprises a surface made from a material suitable for one of several laser desorption mass spectrometry analysis methods such SELDI or DIOS.

18. The apparatus of claim 11, further comprising a positioning stage attached to the electrospray target, such that the target may be moved relative to the microfluidic substrate.

19. The apparatus of claim 11, further comprising a positioning stage attached to the microfluidic substrate, such that the target may be moved relative to the electrospray target.

20. An apparatus for performing microfluidic separations and electrospray of analyte molecules, said apparatus comprising:
a) a substrate containing one or more microchannels, said substrate possessing at least one surface;
b) at least one electrospray microchannel, said microchannel possessing a first end and a second end, wherein the second end terminates at the at least one substrate surface;
c) at least one electrospray reservoir, wherein the reservoir is in fluid communication with the first end of the electrospray microchannel; and
d) at least one separation microchannel, said microchannel possessing a first end and a second end, wherein the second end intersects the electrospray microchannel at a point between the first and second ends of the electrospray microchannel;
e) at least one separation reservoir, wherein the reservoir is in fluid communication with the first end of the separation microchannel;
f) at least one flow control microchannel, said microchannel possessing a first end and a second end, wherein the second end intersects the separation microchannel at a point between the first and second ends of the separation microchannel;
g) at least one flow control reservoir, wherein the reservoir is in fluid communication with the first end of the flow control microchannel;
h) a first voltage source in electrical communication with the electrospray reservoir;
i) a second voltage source in electrical communication with the separation reservoir;
j) a pumping means in fluid communication with the flow control reservoir;
k) at least one porous membrane, said membrane possessing a bonded side and an exposed side, wherein the membrane contains interconnected pores which provide a continuous fluid flow path between the bonded side and the exposed side, and wherein the bonded side of the porous membrane is attached to the substrate surface such that the membrane substantially covers the second end of the electrospray microchannel;

21. A method of performing electrospray, the method comprising the steps of:
a) providing a substrate containing one or more microchannels, said substrate possessing at least one surface;
b) providing at least one electrospray microchannel, said microchannel possessing a first end and a second end, wherein the second end terminates at the substrate surface;
c) providing at least one reservoir, wherein the reservoir is in fluid communication with the first end of the electrospray microchannel; and
d) providing at least one porous membrane, said membrane possessing a bonded side and an exposed side, wherein the membrane contains interconnected pores which provide a continuous fluid flow path between the bonded side and the exposed side, and wherein the bonded side of the porous membrane is attached to the substrate surface such that the membrane substantially covers the second end of the electrospray microchannel;
e) providing at least one electrospray voltage source in electrical communication with the fluid within the reservoir;
f) providing at least one pumping means in fluid communication with the reservoir;
g) providing an electrospray target;
h) positioning the electrospray target such that the exposed surface of the porous membrane is at a fixed distance from the electrospray target;
i) activating the pumping means to introduce an ionic buffer solution into the electrospray microchannel, such that the solution fills the channel, and such that the solution fills the pores within the membrane in the region surrounding the second end of the electrospray microchannels;
j) placing a volume of solution containing sample molecules into the reservoir;
k) activating the pumping means to begin mobilizing sample molecules at a set flow rate from the reservoir to the second end of the electrospray microchannel and through the pores of the membrane attached to the substrate surrounding the second end of the electrospray microchannel;
l) applying a voltage to the electrospray voltage source, such that voltage is transferred through the conductive buffer solution to the second end of the microchannel, through the porous membrane, and to the exposed surface of the membrane, thereby forming an electric potential gradient between the buffer solution on the exposed surface of the membrane and the electrospray target;
m) increasing the applied voltage until stable electrospray is observed from the exposed side of the porous membrane;
n) continuing to activate the pumping means in order to mobilize the sample molecules through the electrospray microchannel, such that the sample molecules traverse the length of the microchannel, pass through the second end of the microchannel, pass through the porous membrane attached to the second end of the microchannel, and are ejected from the exposed surface of the membrane towards the electrospray target by electrospray.

22. The method of claim 21, wherein the conductive surface is the orifice of a mass spectrometer designed for interfacing with an electrospray ionization source.

23. The method of claim 21, wherein the conductive surface is a plate designed for use as a target substrate in matrix-assisted laser desorption/ionization—mass spectrometry.

24. The method of claim 21, wherein the distance between the exposed surface of the porous membrane and the electrospray target is between 0.5 mm and 5 mm.

25. The method of claim 21, wherein the flow rate imposed by the pumping means during active electrospray is greater than 100 nL/min.

26. The method of claim 21, wherein the flow rate imposed by the pumping means during electro spray of sample molecules is between 20 nL/min and 100 nL/min.

27. The method of claim 21, wherein the flow rate imposed by the pumping means during electro spray of sample molecules is less than 20 nL/min.

28. The method of claim 21, further comprising the steps of:
a) introducing at least one species of binding molecules into the interconnected pores within the porous membrane;
b) Controlling the time for which the species of binding molecules remains within the membrane, thereby controlling the degree of binding between the molecules and the membrane;

29. A method of performing microfluidic separations and electrospray of analyte molecules, the method comprising the steps of:
a) providing a substrate containing one or more microchannels, said substrate possessing at least one surface;
b) providing at least one electrospray microchannel, said microchannel possessing a first end and a second end, wherein the second end terminates at the at least one substrate surface;
c) providing at least one electrospray reservoir, wherein the reservoir is in fluid communication with the first end of the electrospray microchannel; and
d) providing at least one separation microchannel, said microchannel possessing a first end and a second end, wherein the second end intersects the electrospray microchannel at a point between the first and second ends of the electrospray microchannel;
e) providing at least one separation reservoir, wherein the reservoir is in fluid communication with the first end of the separation microchannel;
f) providing at least one flow control microchannel, said microchannel possessing a first end and a second end, wherein the second end intersects the separation microchannel at a point between the first and second ends of the separation microchannel;
g) providing at least one flow control reservoir, wherein the reservoir is in fluid communication with the first end of the flow control microchannel;
h) providing a first voltage source in electrical communication with the electrospray reservoir;
i) providing a second voltage source in electrical communication with the separation reservoir;
j) providing a first pumping means in fluid communication with the flow control reservoir;
k) providing a second pumping means in fluid communication with the separation reservoir;
l) activating the second pumping means to introduce a flow of separation medium along the length of the separation microchannel, while simultaneously activating the first pumping means to introduce a flow of electrospray buffer solution along the length of the flow control microchannel and electrospray microchannel;
m) deactivating the second pumping means to stop the flow of separation medium into the separation microchannel;
n) sealing the electrospray reservoir;
o) adjusting the flow rate imposed by the first pumping means to create a stable flow of electrospray buffer along the flow control microchannel, through a portion of the electrospray microchannel, and through the porous membrane;
p) activating the first voltage source to generate stable electrospray from the end of the electrospray microchannel;
q) activating the second voltage source to generate an electric field along the length of separation microchannel.

30. The method of claim 29, wherein the separation medium is a sieving gel commonly used for gel electrophoresis.

31. The method of claim 29, further comprising the step of providing at least one porous membrane, said membrane possessing a bonded side and an exposed side, wherein the membrane contains interconnected pores which provide a continuous fluid flow path between the bonded side and the exposed side, and wherein the bonded side of the porous membrane is attached to the substrate surface such that the membrane substantially covers the second end of the electrospray microchannel.
